(19) United States
(12) Patent Application Publication
(10) Pub. No.: US 2010/0239448 A1
(43) Pub. Date: Sep. 23, 2010

(54) FKM OR FFKM MULTIPLE LAYERS SEAL

(76) Inventor: Emmanuel Uzoma Okoroafor, Hampshire (GB)

Correspondence Address: Edwards Vacuum, Inc., 2041 MISSION COLLEGE BOULEVARD, SUITE 260, SANTA CLARA, CA, 95054, US

(21) Appl. No.: 12/663,486

(22) PCT Filed: Jun. 23, 2008
(86) PCT No.: PCT/GB2008/050478

§ 371 Date: May 5, 2010

(30) Foreign Application Priority Data
Jul. 2, 2007 (GB) 0712779.8

(51) Int. Cl. F16J 15/12; F03B 11/00; F16J 15/10

(52) U.S. Cl. 418/104; 277/652

(57) ABSTRACT

A vacuum pump comprises two stator components and a seal located between the components to provide a fluid-tight seal between the components. The seal comprises an annular plastics tube housing an annular reinforcing member, the tube being at least partially surrounded by a sleeve formed from one of FKM elastomer and FFKM elastomer.

The present invention relates to a seal. The seal finds particular, but not exclusive, use in a vacuum pump.

Vacuum pumps are known which are oil-free in their pumping chambers and which are therefore useful in clean manufacturing environments such as those found in the semiconductor industry. Such dry vacuum pumps are commonly multi-stage positive displacement pumps employing intermeshing rotors in each pumping stage. The rotors may have the same type of profile in each stage or the profile may change from stage to stage.

In a Roots or Northey (“claw”) type dry vacuum pump, the stator is formed from a number of separate stator components, with the rotors being located in the pumping chambers defined between the stator components. It is therefore necessary to provide sealing between the stator components in order to prevent leakage of pumped fluid from the pump and to prevent ambient air from entering the pump. An o-ring seal is typically provided to perform this sealing function.

Dry vacuum pumps are frequently deployed in applications in which they are required to pump substantial quantities of oxidative and/or corrosive fluids, including halogen gases and solvents. Such materials attack the o-ring seals, with the result that the seals may become excessively plastic or very brittle, which can badly affect the integrity of the seal provided between the stator components. The intensity of the attack on the seal is dependant on a number of variables including the pumped fluid, the o-ring material, and the pump temperature.

Seals formed from some FKM elastomers (or fluoro elastomers) such as Viton® A or Viton® B are particularly prone to attack when pumping a corrosive fluid such as fluorine gas at a temperature in excess of 140° C. Existing alternative seals for use in such a harsh pumping environment are formed from an FFKM elastomer (or perfluorinated elastomer) such as Kalrez® or Chemraz®, or other FKM elastomer, such as Viton® Extreme or Aflas®, but these are significantly more expensive than Viton®A and Viton®B. Furthermore, these alternative seals have a relatively high compression set, that is, a relatively high amount of the material fails to return to its original thickness after being subject to a standard compressive load for a fixed period of time, in comparison to FKM elastomers such as Viton® A.

It is an aim of at least the preferred embodiment of the present invention to seek to solve this problem.

The present invention provides seal comprising an annular plastic tube housing a substantially annular reinforcing member, the tube being at least partially surrounded by a cover comprising one of FKM elastomer and FFKM elastomer.

The presence of a reinforcing member within the annular plastic tube can enable the seal to have a very low compression set. The reinforcing member is preferably compression set resistant, and so consequently a high sealing stress may be retained with time by the seal. The cover of elastomer can enable the seal to have a relatively high corrosion resistance together with good leak tightness and low gas permeability. The use of only a cover of relatively expensive FKM or FFKM elastomer can significantly reduce costs in comparison to a seal formed exclusively from an annular body of such material.

The FKM elastomer may comprise one of a Viton® fluoro elastomer (including Viton® Extreme material), available from DuPont, Ausimont, Daikin, and an Aflas® fluoro elastomer, available from Asahi Glass Ltd.

The FFKM elastomer may comprises one of a Kalrez® perfluorinated elastomer, available from DuPont, a Chemraz® perfluorinated elastomer, available from Greene, Tweed & Co, Inc., a Parofluor™ perfluorinated elastomer, a Hifluor™ perfluorinated elastomer, both available from Parker Hannifin Corp., a Simriz® perfluorinated elastomer, available from Freudenberg Simrit LP, and an Isolast® perfluorinated elastomer, available from Busak and Shamban (Trelleborg).

The reinforcing member preferably comprises a metallic coil. Alternative forms for the reinforcing member include a perforated metal or plastic tube, braided metal wires, braided graphite fibres and a flexible graphite tubular pre-form.

As a cover of FKM, or FFKM, elastomer is vacuum compatible, the seal finds particular use in a vacuum pump. Therefore, in another aspect, the present invention provides a vacuum pump comprising two stator components and a seal as aforementioned located between the components such that each component is in contact with the seal to provide a fluid-tight seal between the components.

The cover may be in the form of a sleeve extending about the annular tube, and which is formed from one of FKM elastomer and FFKM elastomer. The sleeve may be moulded or otherwise formed about the tube, and may have a C-shaped cross-section.

Preferred features of the present invention will now be described, by way of example only, with reference to the accompanying drawings, in which:

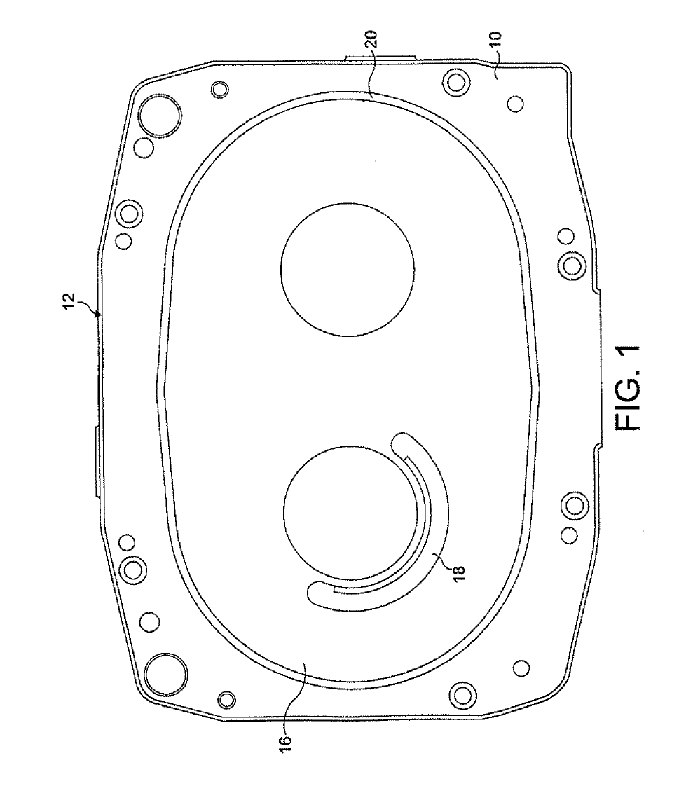

FIG. 1 is a front view of a stator component of a vacuum pump;

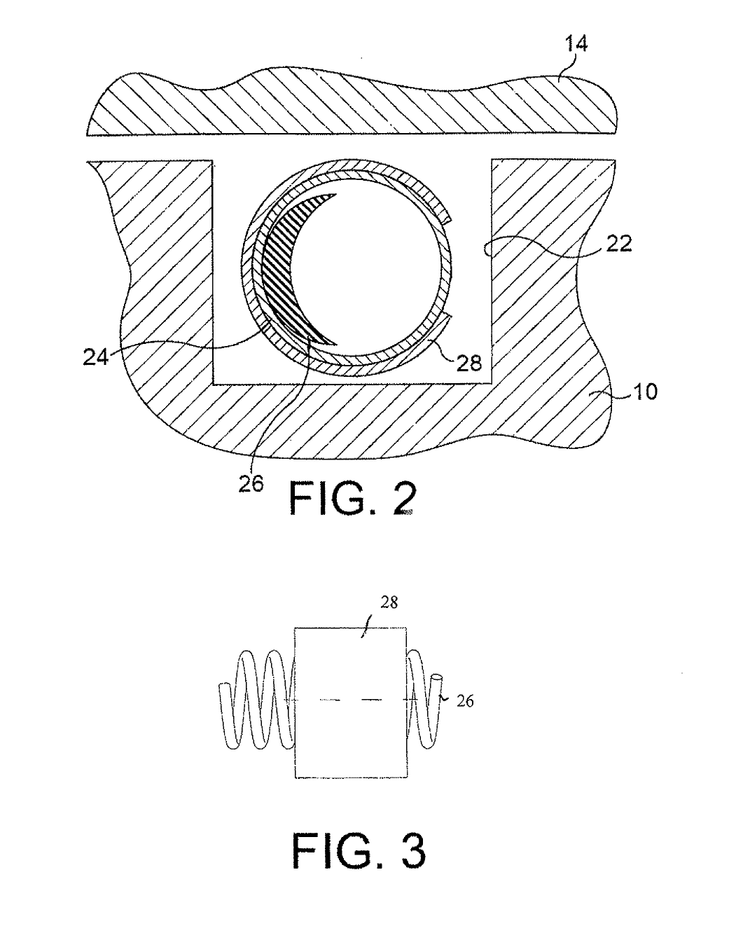

FIG. 2 is a side cross-sectional view of the seal in FIG. 1; and

FIG. 3 is a side view of the seal of FIG. 2 with the outer tube partially removed.

FIG. 1 illustrates the surface 10 of a stator component 12 from a pumping stage of a typical multi-stage dry pump. During pump assembly, a corresponding surface 14 of a second stator component (see FIG. 2) is brought into contact with the surface 10 of the component 12 to form a cavity 16 between the stator components. This cavity 16 is provided to accommodate the rotor components (not shown) of the pump. A dry pump having Roots and/or Northey (“claw”) type rotors typically comprises several such stages, the cavity 16 of each stage communicating with the adjacent downstream stage through a port 18.

As in conventional pumps of this type, a seal 20 is provided around the periphery of the cavity 16 to provide a fluid tight seal between the surfaces 10, 14 of the adjacent stator components such that process fluid is prevented from escaping from the cavity 16 and ambient air is prevented from entering the cavity 16 when the pump is in use.

FIGS. 2 and 3 illustrate one example of a seal 20 according to the present invention. The seal 20 is located within a groove 22 formed in the surface of one of the stator components. The seal 20 comprises an annular plastic tube 24 housing a substantially annular reinforcing member 26. The tube 24 may be formed from any material appropriate to the environment in which the seal is to be used. For use at relatively high temperatures, thermal stability may be provided by forming the annular body from a melt processible fluoroplastic material such as one of fluorinated ethylene propylene (FEP), perfluoroalkoxy (PFA), polychlorotrifluoroethylene (CTFE), polyvinylidene fluoride (PVDF), and polyvinylfluoride (PVF). The annular reinforcing member 26 is preferably provided by a compression set resistant coil. The coil is preferably formed from metallic material, such as stainless steel.

The annular plastic tube 24 is formed from a length of plastic tubing material having an open end through which a length of the reinforcing member 26 is inserted. The tubing material and the length of reinforcing member are then cut to the required length, and the respective ends of the reinforcing member and tubing material are joined together in turn to form the annular reinforcing member 26 surrounded by the annular plastic tube 24. The ends may be joined together by any suitable method, for example welding, adhesive, and so on.

The annular tube 24 is at least partially surrounded by a cover 28 comprising one of FKM elastomer and FFKM elastomer. The choice of elastomer for the cover 28 can be dependent upon a number of factors, including the environment to which the seal will be exposed during use. An FFKM elastomer would be more suitable for use in particularly harsh environments, and this FFKM elastomer may be, for example one of a Kalrez® perfluorinated elastomer, a Chemraz® perfluorinated elastomer, a Parofluor™ perfluorinated elastomer, a Hifluor™ perfluorinated elastomer, a Simriz® perfluorinated elastomer, an Isolast® perfluorinated elastomer s and a Perlast® perfluorinated elastomer. For less harsh environments, where the use of an FFKM elastomer for the cover 28 was considered unnecessary, a cheaper FKM elastomer may be used to form the cover 28. This FKM elastomer may be one of Viton® type F and Viton® Extreme, both available from DuPont, Ausimont, Daikin, and an Aflas® fluoro elastomer, available from Asahi Glass Ltd.

The cover 28 may be in the form of a sleeve which is located about the tube 24. As illustrated in FIG. 2, the sleeve may have a C-shaped cross-section. The cover 28 may be moulded about the annular tube 24, for example using an injection moulding technique. Alternatively, the sleeve may be pre-formed and manually located around the tube 24.

1. A seal comprising an annular plastics tube housing a substantially annular reinforcing member, the tube being at least partially surrounded by a cover comprising one of FKM elastomer and FFKM elastomer.

2. The seal according to claim 1, wherein the cover comprises a sleeve formed from one of FKM elastomer and FFKM elastomer.

3. The seal according to claim 1, wherein the FKM elastomer comprises one of a Viton®—type fluoro elastomer and an Aflas® fluoro elastomer.

4. The seal according to claim 1, wherein the FFKM elastomer comprises one of a Kalrez® perfluorinated elastomer, a Chemraz® perfluorinated elastomer, a Parofluor™ perfluorinated elastomer, a Hifluor™ perfluorinated elastomer, a Simriz® perfluorinated elastomer, an Isolast® perfluorinated elastomer and a Perlast® perfluorinated elastomer.

5. The seal according to claim 1, wherein the tube is formed from a melt processible fluoroplastic.

6. The seal according to claim 1, wherein the reinforcing member comprises a metallic coil.

7. A vacuum pump comprising two stator components and a the seal according to claim 1 located between the components such that each component is in contact with the seal to provide a fluid-tight seal between the components.
